(19) United States
(12) Patent Application Publication
(10) Pub. No.: US 2016/0005036 A1
(43) Pub. Date: Jan. 7, 2016

(54) HCE TOKEN SECURE DELIVERY WITHOUT DATA CONNECTIVITY

(71) Applicant: Mistral Mobile, Oulu (FI)

(72) Inventors: Timo P. Tervo, Oulu (FI); Ludwig Schulze, Forest Hills, NY (US)

(21) Appl. No.: 14/323,991

(22) Filed: Jul. 3, 2014

(51) Int. Cl. G06Q 20/40; G06Q 20/38; H04W 4/14; G06Q 20/32; G06Q 20/36

(52) U.S. Cl. CPC G06Q 20/401; G06Q 20/3255; G06Q 20/367; H04W 4/14; G06Q 20/3829

(57) ABSTRACT

Methods and apparatus, including computer program products, are provided for secure HCE token delivery. In some example embodiments, there may be provided a method, which includes determining, at a user equipment including a host card emulation payment application, whether a data service is allowed and/or available for use; selecting, based on the determining, the data service to carry a message generated by the host card emulation payment application, when the data service is allowed and/or available for use; and selecting, based on the determining, a short message service to carry the message generated by the host card emulation payment application, when the data service is not allowed and/or not available for use. The message may carry tokens, requests for tokens, and/or other information as well. Related apparatus, systems, methods, and articles are also described.

### FIELD

The subject matter described herein relates to mobile payments.

### BACKGROUND

Host Card Emulation (HCE) provides a transfer of transaction information over a short-range wireless link. For example, a wireless device including a Near Field Communications (NFC) transceiver may approach a point-of-sale (POS) terminal (or other types of device) and transfer, via NFC, financial information (for example, personal account information, a token, and the like) to a POS system to complete a purchase. Rather than require a physical, secure smart card, in HCE, a processor at wireless device emulates the smart card, so a physical, separate secure smart card may not be required. In some wireless devices, the operating systems may include HCE support.

### SUMMARY

Methods and apparatus, including computer program products, are provided for secure HCE token delivery.

In some example embodiments, there may be provided a method, which includes determining, at a user equipment including a host card emulation payment application, whether a data service is allowed and/or available for use; selecting, based on the determining, the data service to carry a message generated by the host card emulation payment application, when the data service is allowed and/or available for use; and selecting, based on the determining, a short message service to carry the message generated by the host card emulation payment application, when the data service is not allowed and/or not available for use. The message may carry tokens, requests for tokens, and/or other information as well.

In some variations, one or more of the featured disclosed herein including one or more of the following features can optionally be included in any feasible combination. The data service may include at least one of a cellular data service or an internet protocol data service. The message may be generated to carry a request to a token provider for one or more payment tokens. When the short message service is selected, the message may be converted into a format in accordance with the short message service. When the short message service is selected, at least a portion of the contents of the message may be encrypted. The encryption may comprise symmetric encryption. The encrypted portion may include at least one of a user information, an account number, or a name.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts an example mobile payment system, in accordance with some example embodiments;

FIG. 2 depicts an example process for selecting an SMS channel, when data services are not available at a user equipment, in accordance with some example embodiments;

FIG. 3 depicts an example block diagram of a radio, in accordance with some example embodiments.

FIG. 4 depicts an example process for encrypting messages, in accordance with some example embodiments; and

FIG. 5 depicts examples of key collections, key parts, symmetric keys, messages, and/or the like, in accordance with some example embodiments.

Like labels are used to refer to same or similar items in the drawings.

### DETAILED DESCRIPTION

Host Card Emulation (HCE) using tokens is rapidly surpassing NFC payment approaches using a physical, secure smart card element (also referred to as a secure element (SE)) and a trusted service manager (TSM). The HCE payment tokens may eliminate the need to transmit via NFC a personal account number (PAN) in less secure environments, such as mobile device to point-of-sale (POS) device transactions. These payment tokens may be used to execute transactions in a way that is similar to PAN-based transactions. Moreover, a payment network may be configured to determine that a given token should be routed to an HCE token provider (for example, a source for the tokens). The token provider may provide de-tokenization by matching the token to the actual PAN, after which the PAN can be routed normally in a payment network to for example a bank, credit card issuer, a mobile payment processor, a financial entity, and/or the like. The HCE token providers may be issuers of tokens, processors of tokens, payment network providers, and/or any other type of provider.

The payment tokens transmitted via HCE may be scrambled, encrypted, or anonymized representations of the underlying PAN and include other information, such as cardholder information and the like. For example, the payment token may include a representation of the credit cardholder's zip code, name, PAN, and/or any other information.

An issue with NFC HCE using tokens is that all of the tokens must typically be delivered to the user's user equipment. In order to deliver tokens to the user equipment, connectivity is required. However, data connectivity is not always available. There are many users in for example emerging markets that do not subscribe to data services and/or data connectivity may not be reliable or available. While in developed markets, although data connectivity is more prevalent, connectivity is not universal.

In some example embodiments, the subject matter disclosed herein may include an HCE token provider generating tokens. The HCE token provider may be coupled to the user equipment (which is the destination of the tokens) via a gateway. This gateway may handle messaging to the user equipment in order to operate in environments where data connectivity via for example IP (internet protocol) may be limited. Rather than use data services/connectivity, an out-of-band communication channel, such as an SMS channel, may be activated. Moreover, token delivery over this SMS channel may be encrypted, and cryptographic key materials/deliverables may also be performed over the SMS channel (for example, a secure SMS channel). To illustrate further, a communications controller at the user equipment (or on the network side, at a gateway for example) may select to exchange HCE tokens via an IP data service when available (or allowed), but the communications controller may select an SMS channel, when the IP channel is not active, available, allowed, and/or the like.

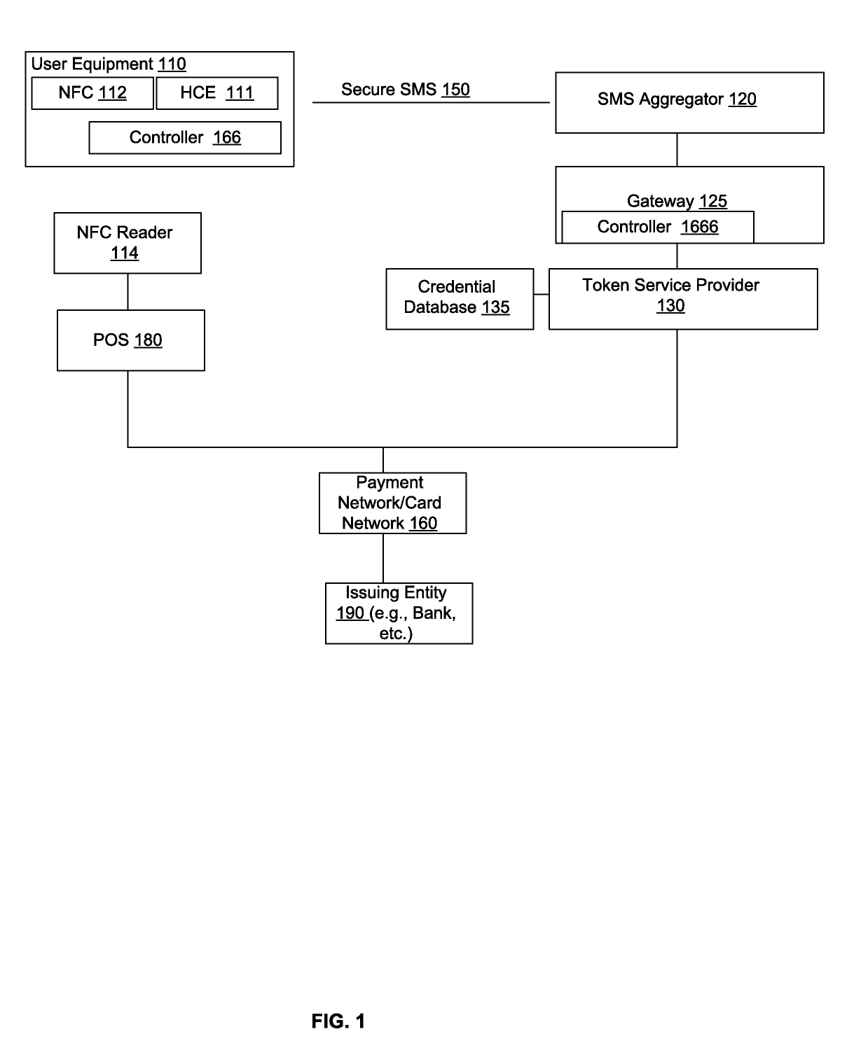

FIG. 1 depicts an example system 100, in accordance with some example embodiments.

The system 100 may include a user equipment 110, such as a cell phone, a smartphone, a tablet, and/or any other device including a short-range transceiver, such as NFC (although other radio technologies may be used as well).

The user equipment 110 may further include an NFC transceiver 112, which can be read by NFC reader 114. For example, user equipment 110 may include a host card emulator 111 and pass a payment token to NFC reader 114 (which is coupled to for example a point-of-sale terminal) in order to initiate a financial transaction, such as purchase an item, make a payment, purchase a ticket, and/or the like.

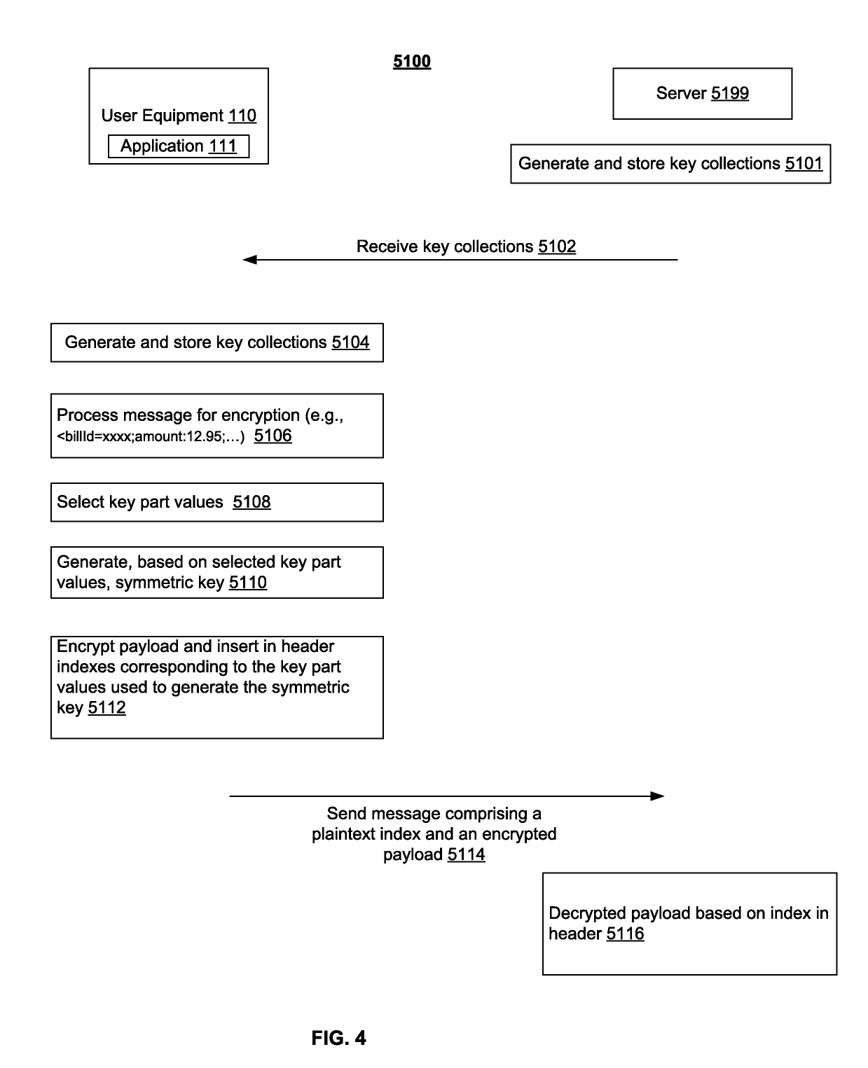

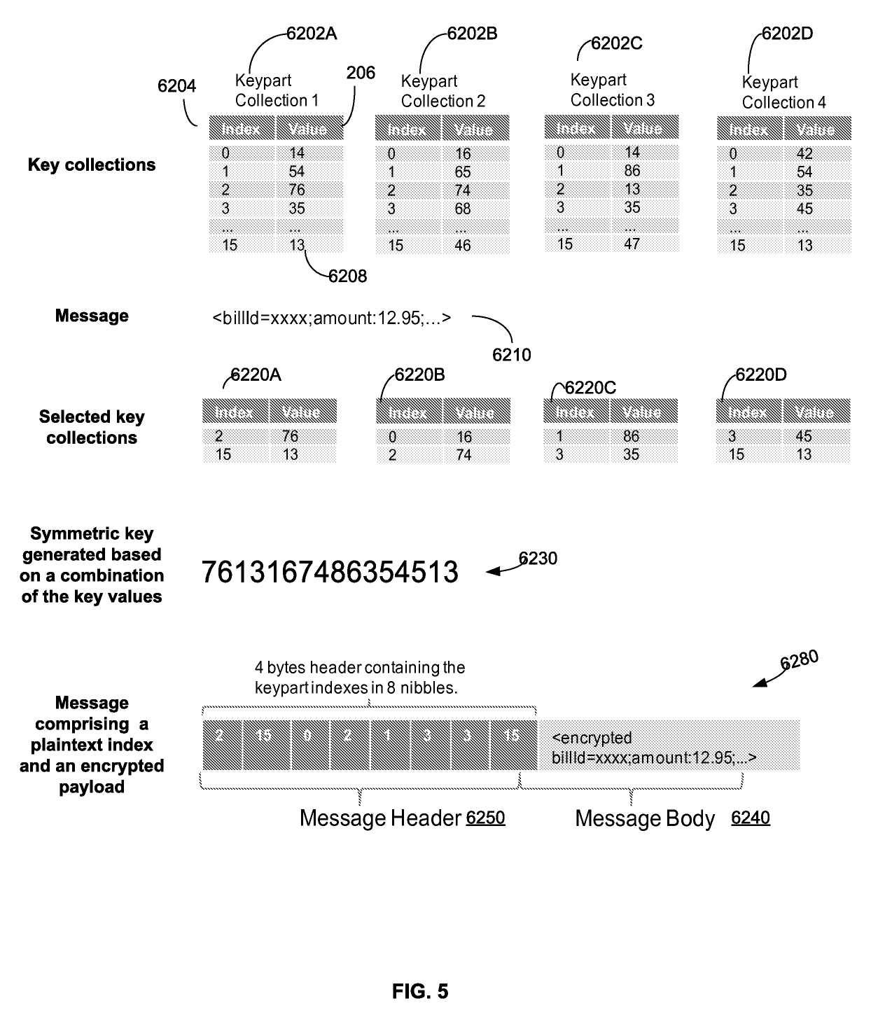

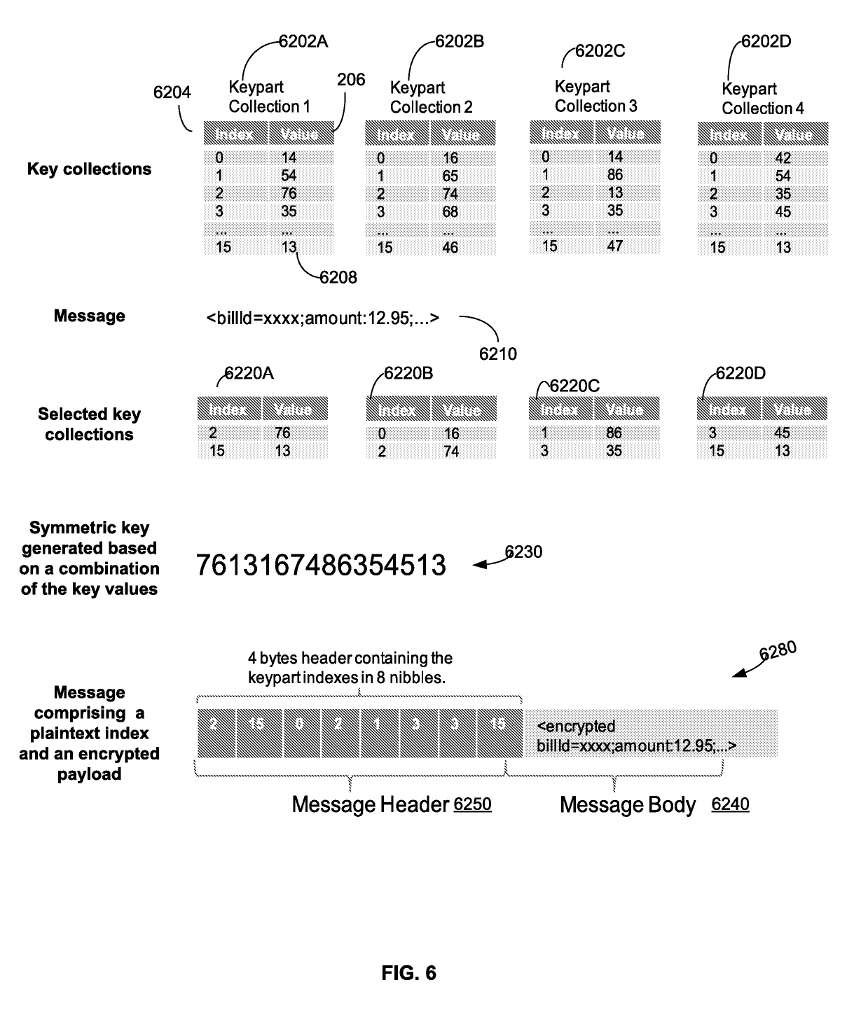

HCE application 111 may be launched, which may initiate a registration process over a data network or via other mechanisms (for example, in-person registration at a kiosk or other location). As part of the initialization of the HCE application, information about the user equipment (and/or user) may be gathered and provided in-band, in-person, and/or in other ways to the token provider and/or other entities and stored at for example database 135. After initialization, HCE application 111 may collect user equipment identification information, such as IMEI (international mobile equipment identifier), Bluetooth ID, WLAN MAC (media access control) address, and/or the like. The equipment identification information may be processed by for example, hashing, encrypting, and/or the like. The HCE application 111 may also collect information from a SIM card at user equipment 110. This collected information may include the IMSI International mobile subscriber identity) of the user equipment 110. The HCE application 111 may then deliver the collected information to gateway 125 via a channel, such as an out-of-band SMS channel 150. Moreover, the contents of the SMS may be encrypted, and the encryption may be in accordance with symmetric encryption, as described with respect to FIGS. 4 and 5 below, although other types of encryption may be used as well. When gateway 125 receives (via line 150 and aggregator 120) the SMS message(s) from user equipment 110, the gateway 125 may decrypt the contents of the message and store the message contents to a secure location. Moreover, gateway 150 may execute a key exchange in order to provision key parts for further data exchange as described below with respect to FIGS. 4 and 5.

The gateway 125 may also forward some of the information in the SMS messages to token service provider 130. The token service provider 130 may perform user verification based on the forwarded information. For example, one or more identifiers for the user equipment 110 may be sent via secure out-of-band channel 150 to the token service provider 130. The one or more identifiers carried by the SMS messages may include identifiers uniquely identifying user equipment 110, such as mobile terminal identifiers, SIM-based identifiers, IMSI, phone number, account information, and/or the like. HCE token provider 130 may then compare the SMS out-of-band identifiers with other information received via other communications channels (for example, an IP data channel from the card/payment network and/or via information collected in-person, during initialization, and/or collected in other ways) to verify that the user equipment is authentic before providing a token to the user equipment. For example, before a token is provided to user equipment 110 via payment network 160 (which may be an IP-based network), HCE token provider 130 may compare the out-of-band identifiers with identification information previously obtained for that user equipment and/or user (and, for example, stored in database 135).

The token service provider may, as noted, compare the identification information contained in the SMS messages received via link 150 and gateway 125 to other information stored at database 135. For example, database 135 may include user and/or user equipment information obtained during the initial registration or initiation of the HCE service at user equipment 110. If the comparison determines that the verification information received via link 150 and gateway 125 compares favorably to the other verification information stored at database 135 (which was previously obtained via other channels, such as in-person, during registration/initialization, and/or the like), token service provider may then proceed to replenish the HCE tokens. If not consistent, the token provider may flag that additional review may be needed before providing a token (and thus not provide a token).

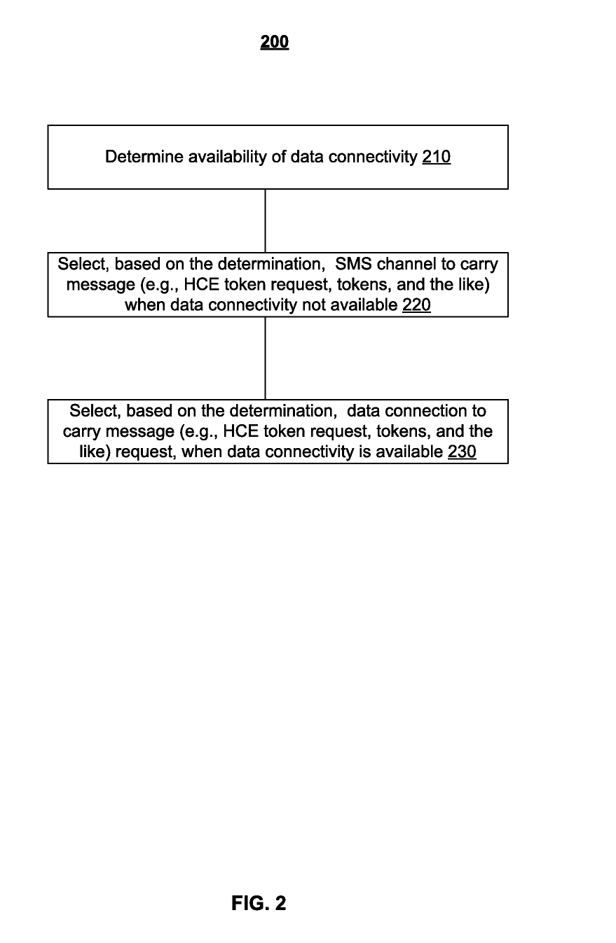

In some example embodiments, when data connectivity is not available over an IP network, Internet, and/or the like, HCE token delivery may be via SMS. Moreover, the selection of the SMS channel 150 or an IP data connection or service may be performed by controller 166 and/or controller 1666 as shown in FIG. 2.

To illustrate, HCE application 111 (and/or gateway 125) may include a communication controller 166/1666 that determines the availability of a data connection, such as an IP data connection. If that data connection is not available, the communication controller may route token requests, responses to requests (for example tokens), and other messages via SMS link 150. Moreover, the message may be encrypted with symmetric encryption as described below with respect to FIGS. 4 and 5, although other encryption techniques may be used as well.

In some example embodiment, user equipment 110 may request a token by requesting connectivity from a communication controller 166, which determines whether a data connection is available or not. If there is no IP data connectivity is available (or for example allowed), the communication controller 166 may convert the request for a token(s) to an SMS protocol formatted message(s). Moreover, the HCE application 111 (and/or communication controller 166) may encrypt the SMS message using symmetric encryption as described below with respect to FIGS. 4 and 5, although other encryption techniques may be used as well.

The encrypted SMS messages may be carried via link 150 to the SMS aggregator 120 (or short message service center, SMSC) and gateway 135, where decryption may take place. For example, if the SMS message(s) are encrypted with symmetric encryption, gateway 135 may decrypt the messages as described further below with respect to FIGS. 4 and 5. The gateway 125 may then forward the message(s) (which may include for example the request for token(s) and/or other information) via a communication channel to token provider 130. When the token service provider 130 receives the request, token service provider 130 may generate one or more tokens.

In some example embodiments, a generated token may be sent via communication controller 1666 that determines the availability of a data connection. If an IP connection (for example, via the Internet, a cellular data link, and/or the like) is not available, the communication controller 166 may route token requests, responses to the generated token via SMS link 150, and/or the like to user equipment 110. The communication controller 1666 may be located at the token provider 130 and/or gateway 125. If an IP connection is available, the communication controller 1666 may route the messages containing the token to an IP network, such as payment network 160, the Internet, and the like. Moreover, the message containing the token may be encrypted with symmetric encryption as disclosed herein, although other encryption techniques may be used as well.

When the token is received by user equipment 110, the token is transferred via NFC to NFC reader 114 and a point-of-sale (POS) system to provide payment (or promise to pay), which is then processed by payment network 160 and/or an issuing entity, such as a bank 190 and the like.

FIG. 2 depicts an example process 200 for smart communications, in accordance with some example embodiments. The description of process 200 refers to FIG. 1.

At 210, a communication controller may determine the availability of data services, in accordance with some example embodiments. For example, communication controller 166 and/or 1666 may have a message, such as a token request, keys, tokens, and/or the like, to send to a destination. When this is the case, the communications controller may determine whether a data service connection, such as an IP data service is available (or allowed to be used) to/from user equipment 110.

At 220, the communication controller 166 and/or 1666 may select the SMS channel, when the IP data service is not available (or not allowed to be used) to/from user equipment 110. When this is the case, the messages, such as token request, tokens, and/or the like, may be carried via SMS and/or may be encrypted as noted above. The communication controller 166 and/or 1666 may format the data into SMS before being carried via SMS. Moreover, the data may be encrypted as noted above.

At 230, the communication controller 166 and/or 1666 may select the an IP data service, when the IP data service is available (or allowed to be used) to/from user equipment 110. When this is the case, the messages, such as token request, tokens, and/or the like, may be carried via an IP data service and/or may be encrypted as noted above.

FIG. 4 depicts a block diagram of a radio 400, such as user equipment 110 or access point (for example, a base station or other type of network node). In some example embodiments, radio 400 may include a communication controller 166/1666 (as disclosed herein).

The radio 400 may include an antenna 420 for receiving a downlink and transmitting via an uplink. The radio 400 may also include a radio interface 440, which may include other components, such as filters, converters (e.g., digital-to-analog converters and/or the like), symbol demappers, signal shaping components, an Inverse Fast Fourier Transform (IFFT) module, and/or the like, to process symbols carried by a downlink or an uplink. In some implementations, radio 400 may also be compatible with WiFi, Bluetooth, GERAN, UTRAN, E-UTRAN, first generation (1G) communication protocols, second generation (2G or 2.5G) communication protocols, third-generation (3G) communication protocols, fourth-generation (4G) communication protocols and/or any other standards, radio access technologies, and specifications as well. Moreover, radio 400 may be configured to support messaging, such as SMS messages. The radio 400 may further include at least one data processor, such as data processor 430 (e.g., a microprocessor and/or the like) for controlling radio 400 and for accessing and executing program code stored in memory 435. For example, memory 435 may include code for performing one or more of the operations disclosed herein (e.g., process 200, encrypting messages, controlling selection of connectivity, and/or the like).

The following describes an encryption approach, which may be used in some example embodiments. Specifically, a mobile application (for example, HCE application 111 and/or a corresponding application at the gateway or token provider), may receive a key collection including a plurality of key parts. These key parts may include key values and indexes. A key value represents a portion of a symmetric key, and an associated index identifies the key value in a certain key collection. For example, when information is received for secure transmission by the mobile application, the mobile application may select 2 key parts (i.e., key values and corresponding indexes) from each of the 4 key collections, although other quantities of key values and key collections may be used as well. The mobile application/HCE application 111 may then combine the selected key values to form a symmetric key, which is then used to encrypt the received information. The mobile application/HCE application 111 may then generate a short message service (SMS) message carrying at least a header portion and a payload portion. The payload may include the encrypted information, and the header may represent the indexes identifying which key values were selected to form the symmetric key. The application 111 may then send the SMS message to a server (for example, gateway 125, token service provider 130, and/or any other network node), where the SMS message is decrypted. In some example embodiments, the symmetric key is dynamically generated in the sense that each piece of information, such as financial transaction information, requiring transmission to the server is encrypted with a unique, one-time key. Moreover, the key collections at the application 111 may be updated with another key collection, when the possible key combinations have been exhausted, when the keys have been compromised, and/or any other time new key collections are desired. The subject matter disclosed herein may, in some example implementations, provide symmetric encryption for SMS communication and the like using a dynamic, one-time use symmetric key formed from key parts shared by the sender and receiver.

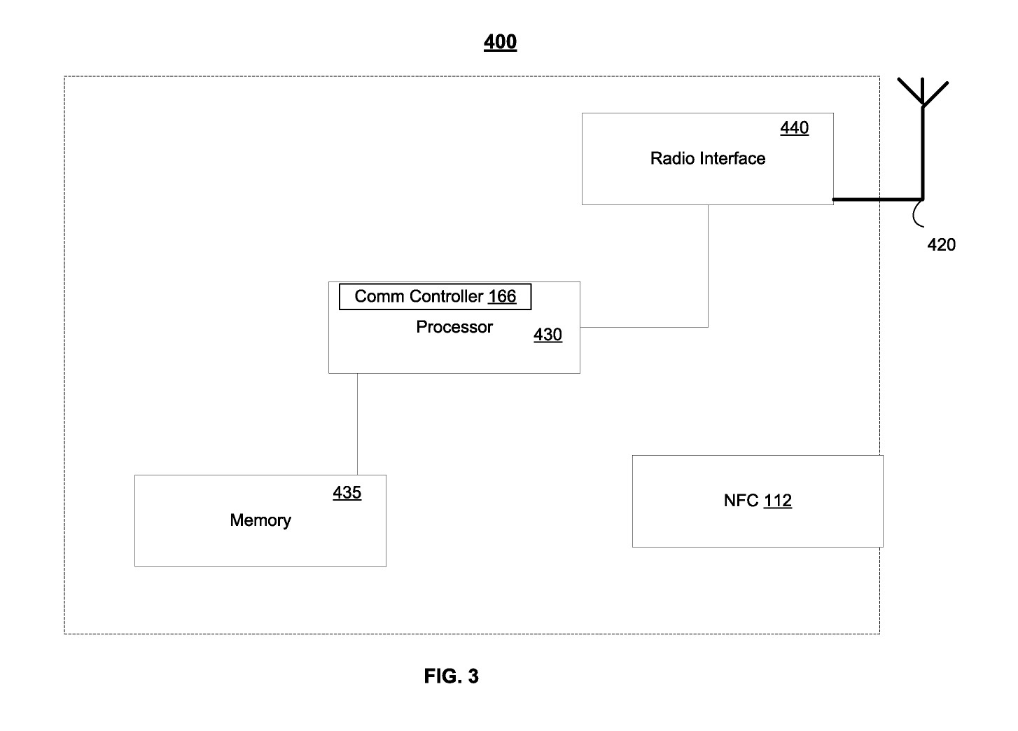

FIG. 3 depicts an example process 5000 for providing secure transactions, in accordance with some example embodiments. The description of FIG. 4 also refers to FIG. 5.

In some exemplary embodiments, user equipment 110 may be implemented as a mobile wireless device. The user equipment 110 may be referred to as, for example, a mobile station, a mobile unit, a subscriber station, a wireless terminal, a tablet, a smart phone, a cell phone, and/or the like. The user equipment may be implemented as, for example, a wireless handheld device, a wireless plug-in accessory, and/or the like. In some cases, the user equipment may include a data processor, a computer-readable storage medium (e.g., memory, storage, and/or the like), a radio access mechanism, and/or a user interface. Moreover, the user equipment may include one or more applications, such as application 111 stored as code in memory and executable by a data processor. Furthermore, user equipment 110 may be configured to send SMS messages to SMS aggregator 120 via a wireless access point, such as a base station, a WiFi access point, and/or the like, interfaced to the public land mobile network.

Server 199 may include a data processor and a computer-readable storage medium (e.g., memory, storage, and/or the like). In some example embodiments, server 199 may be implemented as gateway 125 having a first interface to a SMS aggregator 120 (and/or SMS provider) and a second interface to other systems, such as token provider 130. Although gateway 125 is depicted separate form token provider 130, in some example embodiments, the token provider 130 includes gateway 130 (and thus server 5199).

At 5101, the server 5199 may generate and store key collections. For example, server 199 may comprise a data processing device configured to generate key collections. Specifically, server 5199 may randomly generate and store key collections, each of which includes indexes and corresponding key values. The key values represent portions of a symmetric key, and when some of these portions are combined, the combined portions form a symmetric key used to encrypt information using a symmetric encryption engine, such as AES and/or the like. In some example embodiments, server 199 includes a security module that generates, or receives from a key generator, 4 key collections, as depicted at FIG. 5 (although other quantities may be used as well). These key collections may then be securely stored at server 5199.

The example of FIG. 5 depicts 4 key collections 6202A-D, and the key collections include indexes 6204 and key values 6206. Each of the indexes uniquely maps, and thus identifies, a certain key value. In some example embodiments, each of the key collections includes 16 key parts, each comprising an index and a key value. For example, these 16 key parts at key collection 6202A comprise index 0 and key value 14, index 1 and key value 54, index 2 and key value 54, and so forth through index 15 and corresponding key value 13. Moreover, any key value can be identified uniquely based on its collection and index. For example, key value 13 (at 6208) can be uniquely identified by specifying the key collection and index, which in this example is key collection 1 and index 15 (e.g. 1, 15). In any case, the key values can be combined by, for example, concatenating the key values to form a symmetric key as further described below. In some example embodiments, additional layers of security may be provided so long both endpoints are aware of those additional layers to enable processing. For example, key values may be built in other ways from the shared key collection and index information so long as both endpoints are aware of the way being used.

Referring again to FIG. 4 at 5101, once the key collections are generated, server 199 may store the key collections in a secure manner, such as using a dedicated secure storage mechanism including, for example, a hardware security module (HSM).

At 5102, the server 5199 may send the key collections generated and stored at 5101 to user equipment 110. For example, server 5199 may share the key collections 6202A-D with user equipment 110 including HCE application 111 by sending the key collections 6202A-D. In some example embodiments, the key collections may be sent via at least a wireless link carrying a encrypted SMS message as disclosed herein (e.g., an index and an encrypted payload, using for example AES, as disclosed herein), although the key collections may be sent in other ways as well. For example, when the client device, such as user equipment 100, connects to server 5199 for the first time, user equipment 110 may obtain the initial key collections (and/or other software and/or data for the application 111) via a secure connection using, for example, a shared service public key. After that initial key collection delivery, the encrypted SMS messages disclosed herein may be used to share the key collections.

Once the user equipment 110 receives the key collections, user equipment 110 may then store at 5104 the key collections. Moreover, the application 111 and/or user equipment 110 may receive key collections 6202A-D and then store the key collections 6202A-D securely using, for example, local encrypted, or otherwise secure, storage.

At 5106, a message may be processed for encryption, in accordance with some example embodiments. For example, HCE application 111 and/or user equ the communication controller 166 and/or 1666 may ipment 110 may have a message for transmission, such as a bill pay message (“<billId=xxxx;amount:12.95>”) 6210 at FIG. 5. In this example, the message represents a financial transaction to be carried by an SMS message securely, and, in particular, a user of user equipment 110 submitting bill payment to server 5199.

At 5108, the application 111 at user equipment 110 may select key parts. For example, application 111 may randomly select 2 key parts from each collection, as depicted at 6220A-D at FIG. 5.

At 5110, a symmetric key may be generated, based on the selected key parts. For example, user equipment 110 and/or application 111 may select the key values from each of the selected key parts 6220A-D and then combine those key values to form a symmetric key. Referring again to FIG. 5, the generated key is 7613167486354513 (at 6230). This generated key represents the concatenation of the selected key values, 76 and 13, from the first collection, the key values, 16 and 74, from the second collection, the key values, 86 and 35, from the third collection, and the key values, 45 and 13, from the fourth collection.

In some example embodiments, the generated symmetric key may also be hashed using user equipment 110's Mobile Station International Subscriber Directory Number (MSISDN), a Bluetooth universally unique identifier (UUID), or any other identifier (which would also be known by the server 5199).

At 5112, the symmetric key may be used to encrypt the message payload, and a plaintext header including indexes may be appended to the payload. For example, the message payload, “<billId=xxxx;amount:12.95>”, may be encrypted symmetrically using the key generated at 5110. The indexes for the selected key collections may then be combined and inserted into a header. This header may be in plaintext, i.e., not encrypted by the symmetric key. Referring again to FIG. 5, the message body 6240 includes the encrypted payload of “<billId=xxxx;amount:12.95>.” The message header 6250 includes the indexes for the selected key values contained in the symmetric key, so that the index uniquely indentifies all of the key value pieces used to form the entire symmetric key 6230. For example, the message header 6230 includes indexes 2 and 15 from the first collection 6220A, indexes 0 and 2 from the second collection 220B, indexes 1 and 3 from the third collection 6220C, and indexes 3 and 15 from the fourth collection 6220D. Because the message header 6230 includes the ordered indexes from each key collection 6220A-D, the server 5199 will be able to determine symmetric key 6230 based on the plaintext index contained in the message header 6250. In some example embodiments, the symmetric encryption is AES, although other symmetric encryption techniques may be used as well.

Although the message header 6250 at FIG. 5 includes the indexes in a predetermined order corresponding to the collections 6202A-D, the indexes may be placed in the header in other orders as well. When this is the case, server 5199 may be configured to know the index placement technique used at the user equipment to access the key values in the key collections.

In some example embodiments, the message body 6240 may also be signed using, for example, a hash as noted above. This hash may be implemented as a Secure Hash Algorithm (SHA) and/or MD5, although other hash techniques may be used as well.

In the example of FIG. 5, as symmetric key creation relies on 4 key collections from which 2 key parts among 16 are randomly selected, the amount of unique combinations is 262,144 (i.e., 4 times 2¹⁶). Moreover, the header 6250 may, in some example embodiments, contains 4 bytes reserved to receive the 8 indexes of the key parts necessary to re-generate the symmetric key for decrypting the message body 6240. Each of these indexes fit into one nibble (i.e., a half-byte whose value is between 0-15), so the 8 indexes of the key parts can be set using only 4 bytes (i.e., 8×½ byte). Although some of the examples described herein refer to specific quantities of key values, key collections, and indexes, other quantities may be implemented as well.

At 5114, the message may be sent to server 5199. Referring again to FIG. 5, user equipment 110 may send message 6280 including message header 6250 and message body 6240 to server 5199. Moreover, message 6280 may be sent via SMS or any other connectivity channel between client and server. Specifically, user equipment 110 may provide message 6280 to an SMS interface at the user equipment 110 for sending the message 6280 via SMS. The server 5199 may have an interface to an SMS provider, which provides the SMS message 6280 to server 5199. In this example, the server 5199 may obtain the user equipment's MSISDN from the SMS service provider and determine the key parts used based on the header 250 carried by the SMS message.

At 5116, server 5199 may decrypt the message based on the index in the header. For example, server 5199 may read the header comprising 2, 15, 0, 2, 1, 3, 3, and 15 and then access the key collections to identify the key values forming the symmetric key (e.g., 7613167486354513) used by user equipment 110 to send the message. Using the symmetric key, server 5199 may then decrypt the message into plaintext. When hashing is used, the server 5199 may hash the symmetric key before decrypting the message.

In some example embodiments, the server 199 may send an acknowledgement message to user equipment 110 to confirm receipt of the message received by server 5199 at 110. This acknowledgement may be sent as an SMS message. Moreover, this SMS acknowledgement message may carry a payload encrypted using the same key used to encrypt the payload of the message received at 5114, although a different key may be generated using the key collections.

In some example embodiments, each generated symmetric key is used only during one request/response sequence before it is discarded. When this is the case, the user equipment 110 may store and keep a record of all the used key parts combinations. Moreover, the record may allow server 5199 to reject any incoming messages that use an already-used symmetric key. Furthermore, once a certain amount of key parts combinations have been used or when the key collections (or portions thereof) have been compromised, server 199 may, in some example embodiments, decide to renew the key collections by resending a new set of key collections at 5102.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, computer-readable storage medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

What is claimed:

1. A method comprising:
determining, at a user equipment including a host card emulation payment application, whether a data service is allowed and/or available for use;
selecting, based on the determining, the data service to carry a message generated by the host card emulation payment application, when the data service is allowed and/or available for use; and
selecting, based on the determining, a short message service to carry the message generated by the host card emulation payment application, when the data service is not allowed and/or not available for use.

2. The method of claim 1, wherein the data service comprises at least one of a cellular data service or an internet protocol data service.

3. The method of claim 1 further comprising:
generating the message to carry a request to a token provider for one or more payment tokens.

4. The method of claim 1, wherein when the short message service is selected, the method further comprises:
converting the message into a format in accordance with the short message service.

5. The method of claim 1, wherein when the short message service is selected, the method further comprises:
encrypting at least a portion of the contents of the message.

6. The method of claim 5, wherein the encryption comprises symmetric encryption.

7. The method of claim 5, wherein the encrypted portion includes at least one of a user information, an account number, or a name.

8. An apparatus comprising:
at least one processor; and
at least one memory including program code which when executed by the at least one processor causes operations comprising:
determining, at the apparatus including a host card emulation payment application, whether a data service is allowed and/or available for use;
selecting, based on the determining, the data service to carry a message generated by the host card emulation payment application, when the data service is allowed and/or available for use; and
selecting, based on the determining, a short message service to carry the message generated by the host card emulation payment application, when the data service is not allowed and/or not available for use.

9. The apparatus of claim 8, wherein the data service comprises at least one of a cellular data service or an internet protocol data service.

10. The apparatus of claim 8 further comprising:
generating the message to carry a request to a token provider for one or more payment tokens.

11. The apparatus of claim 8, wherein when the short message service is selected, the method further comprises:
converting the message into a format in accordance with the short message service.

12. The apparatus of claim 8, wherein when the short message service is selected, the method further comprises:
encrypting at least a portion of the contents of the message.

13. The apparatus of claim 12, wherein the encryption comprises symmetric encryption.

14. The apparatus of claim 12, wherein the encrypted portion includes at least one of a user information, an account number, or a name.

15. A non-transitory computer-readable storage medium including program code which when executed by at least one processor causes operations comprising:
determining, at a host card emulation payment application, whether a data service is allowed and/or available for use;
selecting, based on the determining, the data service to carry a message generated by the host card emulation payment application, when the data service is allowed and/or available for use; and
selecting, based on the determining, a short message service to carry the message generated by the host card emulation payment application, when the data service is not allowed and/or not available for use.

16. A method comprising:
selecting, by a network node, a data service to carry a message to a host card emulation payment application, when the data service is allowed and/or available for use; and
selecting, by the network node, a short message service to carry the message generated by the host card emulation payment application, when the data service is not allowed and/or not available for use.

17. The method of claim 16, wherein the contents of the message include one or more payment tokens for use by a host payment application at a user equipment.

18. The method of claim 16, wherein the network node comprises a communications controller.

19. An apparatus comprising:
at least one processor; and
at least one memory including program code which when executed by the at least one processor causes operations comprising:
selecting, by a network node, a data service to carry a message to a host card emulation payment application, when the data service is allowed and/or available for use; and
selecting, by the network node, a short message service to carry the message generated by the host card emulation payment application, when the data service is not allowed and/or not available for use.

20. A non-transitory computer-readable storage medium including program code which when executed by at least one processor causes operations comprising:
selecting, by a network node, a data service to carry a message to a host card emulation payment application, when the data service is allowed and/or available for use; and
selecting, by the network node, a short message service to carry the message generated by the host card emulation payment application, when the data service is not allowed and/or not available for use.
